(19) United States
(12) Patent Application Publication
(10) Pub. No.: US 2022/0097383 A1
(43) Pub. Date: Mar. 31, 2022

(54) PRINTING APPARATUS

(71) Applicant: Seiko Epson Corporation, Tokyo (JP)

(72) Inventors: Masaki SHIMOMURA, Matsumoto-shi (JP); Seiya SATO, Matsumoto-shi (JP)

(21) Appl. No.: 17/488,567

(22) Filed: Sep. 29, 2021

(30) Foreign Application Priority Data
Sep. 29, 2020 (JP) 2020-162931
Sep. 10, 2021 (JP) 2021-147577

(51) Int. Cl. B41J 2/165

(52) U.S. Cl. CPC B41J 2/16538; B41J 2002/16576; B41J 2/1652

(57) ABSTRACT

A printing apparatus includes a line head, a wiper unit, and a guide. The line head is configured to eject ink from an ejection surface extending in an A direction. The wiper unit includes a wiping portion configured to wipe the ink and a liquid container configured to hold the wiped ink. The wiper unit is configured to move in a Y direction and clean the ejection surface with the wiping portion. The guide extends in the Y direction and guides the wiper unit. The wiper unit includes a guided portion configured to be guided by the guide. The ink container and the guided portion form an overlap in the A direction when viewed in the Y direction.

The present application is based on, and claims priority from JP Application Serial Number 2020-162931, filed Sep. 29, 2020, JP Application Serial Number 2021-147577, filed Sep. 10, 2021, the disclosures of which are hereby incorporated by reference herein in its entirety.

### BACKGROUND

### 1. Technical Field

The present disclosure relates to a printing apparatus.

### 2. Related Art

The ink jet printer disclosed in JP-A-8-300672 wipes ink from the tilted ink jet head with a wiper.

Hereinafter, an ink jet head is referred to as a recording portion, and a wiper is referred to as a wiping portion. As in the ink jet printer disclosed in JP-A-8-300672, in a printing apparatus including a tilted recording portion, which ejects a liquid for recording, the recording portion may be cleaned by a cleaner including a wiping portion, which wipes the liquid from the recording portion, and a liquid container, which holds the wiped liquid. Furthermore, the printing apparatus may include a guide that guides a guided portion of the cleaner in a movement direction to allow the cleaner to clean the recording portion while moving. The liquid container may be located close to the wiping portion to allow the wiped liquid to straightly enter the liquid container. However, when the liquid container is located close to the wiping portion, the guide is farther from the wiping portion than the liquid container is. In this configuration, when the wiping portion wipes the liquid from the recording portion, a load due to torsion may act on the guided portion, because the guide is away from the point of application of force on the wiping portion.

### SUMMARY

To solve the above-described problem, a printing apparatus according to an aspect of the present disclosure includes a recording portion configured to eject a liquid from an ejection surface extending in an intersecting direction intersecting a vertical direction to record on a medium, a cleaner including a wiping portion configured to wipe the liquid from the ejection surface and a liquid container located below the wiping portion in the vertical direction and configured to hold the liquid wiped by the wiping portion, the cleaner being configured to move in a movement direction intersecting both the vertical direction and the intersecting direction and clean the ejection surface with the wiping portion, and a guide extending in the movement direction and configured to guide the cleaner. The cleaner includes a guided portion configured to be guided by the guide, and the liquid container and the guided portion form an overlap in the intersecting direction when viewed in the movement direction.

### BRIEF DESCRIPTION OF THE DRAWINGS

FIG. 1 is a view indicating a transportation path of a medium in a printer according to an embodiment.

FIG. 2 is a side view illustrating the inside of the printer according to the embodiment seen from behind.

FIG. 3 is a bottom view illustrating a line head and a blade cleaning an ejection surface of the line head according to the embodiment.

FIG. 4 is a perspective view illustrating a wiper unit and a drive unit according to the embodiment.

FIG. 5 is a perspective view illustrating a wiper unit and a guiding portion according to the embodiment.

FIG. 6 is a side view illustrating the wiper unit and the guiding portion according to the embodiment.

FIG. 7 is a perspective view illustrating a frame unit according to the embodiment.

FIG. 8A is a perspective view illustrating a blade unit according to the embodiment.

FIG. 8B is a perspective view illustrating a cover of the blade unit according to the embodiment in a non-transparent state.

FIG. 9 is a perspective view illustrating components around a main shaft of the wiper unit according to the embodiment.

FIG. 10 is a perspective view illustrating components around an auxiliary shaft of the wiper unit according to the embodiment.

FIG. 11 is a vertical cross-sectional view illustrating an internal structure of the wiper unit according to the embodiment.

FIG. 12 is a perspective view indicating how forces are applied to the wiper unit according to the embodiment.

FIG. 13 is a side view illustrating a wiper unit according to a modification of the embodiment.

FIG. 14 is a diagram showing the periphery of a drive pulley, a wiper carriage, and a driven pulley of the printer according to the embodiment.

FIG. 15 is a perspective view of the periphery of the driven pulley of the wiper unit according to the embodiment.

FIG. 16 is a perspective view of the periphery of the driven pulley of the wiper unit according to the embodiment, and is a view seen from an angle different from that of FIG. 15.

### DESCRIPTION OF EXEMPLARY EMBODIMENTS

Hereinafter, an outline of the present disclosure will be described. A printing apparatus according to an aspect of the present disclosure includes a recording portion configured to eject a liquid from an ejection surface extending in an intersecting direction intersecting a vertical direction to record on a medium, a cleaner including a wiping portion configured to wipe the liquid from the ejection surface and a liquid container located below the wiping portion in the vertical direction and configured to hold the liquid wiped by the wiping portion, the cleaner being configured to move in a movement direction intersecting both the vertical direction and the intersecting direction and clean the ejection surface with the wiping portion, and a guide extending in the movement direction and configured to guide the cleaner. The cleaner includes a guided portion configured to be guided by the guide. The liquid container and the guided portion form an overlap in the intersecting direction when viewed in the movement direction.

When the cleaner is moved in the movement direction, the wiping portion wipes the liquid from the ejection surface. The wiped liquid is held in the liquid container. When the wiping portion wipes the liquid from the ejection surface, a reaction force in a direction opposite the movement direction acts on the wiping portion at a point of application of force. This reaction force causes a moment of force at the contact point between the guide and the guided portion. In the configuration according to the present aspect, the liquid container and the guided portion form an overlap in the intersecting direction. This shortens the distance from the wiping portion to the contact point between the guide and the guided portion. Thus, the moment of force acting on the contact point between the guide and the guided portion is smaller than that in a configuration in which the guided portion is farther from the wiping portion than the liquid container and a configuration in which the liquid container and the guided portion do not form an overlap in the intersecting direction. In the configuration according to the present aspect, a load due to torsion is less likely to act on the guided portion.

In the printing apparatus, the wiping portion and the liquid container may form an overlap in an apparatus width direction perpendicular to the vertical direction.

This configuration requires a smaller installation space for the wiping portion and the liquid container in the apparatus width direction than a configuration including a wiping portion and a liquid container arranged in the apparatus width direction. This enables the printer to be smaller in the apparatus width direction.

In the printing apparatus, the liquid container and the wiping portion may form no overlap in a perpendicular direction perpendicular to the ejection surface.

In this configuration, the liquid container and the wiping portion form no overlap in the perpendicular direction. This enables the path through which the liquid flows from the wiping portion to the liquid container to be long. In other words, the path from the liquid container to the wiping portion is made long. This prevents the liquid from reattaching to the wiping portion when the ink flowing toward the liquid container flows back toward the wiping portion.

The printing apparatus may further include a drive configured to move the cleaner in the movement direction, an auxiliary guide extending in the movement direction parallel to the guide, and an auxiliary guided portion configured to be guided by the auxiliary guide. The wiping portion is a blade elongated in one direction. The drive is configured to move a portion including the guided portion of the cleaner in the movement direction. In the intersecting direction, a first distance from the guided portion to a center of the blade in the one direction is shorter than a second distance from the auxiliary guided portion to the center.

In this configuration, the guided portion, which directly receives a driving force from the drive, is located closer than the auxiliary guided portion, which does not directly receive a driving force from the drive, to the blade. In other words, this configuration further shortens the distance from the blade to the point of application where the driving force of the drive acts. Thus, a load due to torsion is less likely to act on the guided portion.

In the printing apparatus, the guided portion may be located below the auxiliary guided portion in the vertical direction.

The liquid wiped by the wiping portion flows downward in the vertical direction under its own weight. In this configuration, the guided portion is located below the auxiliary guided portion in the vertical direction, and thus the liquid container is located below the wiping portion in the vertical direction. Thus, the liquid wiped by the wiping portion is efficiently gathered into the liquid container without a component that guides the liquid into the liquid container.

In the printing apparatus, the guide may include a first plate having a thickness in the intersecting direction and a second plate having a thickness in a perpendicular direction perpendicular to the ejection surface, the auxiliary guide may include a third plate having a thickness in the perpendicular direction, the guided portion may be in contact with the first plate in the intersecting direction, a sandwiching portion sandwiching the second plate with the guided portion in the perpendicular direction may be disposed on the guided portion, and the auxiliary guided portion may have a recess in which the third plate is inserted in the intersecting direction.

In this configuration, the guided portion is in contact with the first plate in the intersecting direction and the guided portion and the sandwiching portion sandwich the second plate in the perpendicular direction. This limits the movement of the guided portion in the intersecting direction and the perpendicular direction. Thus, the cleaner is less likely to misalign with the guide. The auxiliary guided portion is freely movable in the intersecting direction in addition to the movement direction. In this configuration, when a reaction force opposite the movement direction acts on the wiping portion, the auxiliary guided portion and the auxiliary guide are less likely to come in contact with each other. Thus, a load due to torsion is less likely to act on the auxiliary guided portion.

In the printing apparatus, the ejection surface may have outlets arranged in an arrangement direction intersecting the movement direction, and the blade may be located such that the one direction extends in the arrangement direction.

In this configuration, the blade is elongated in the one direction, which is the arrangement direction of the nozzles. Thus, when the wiping portion is moved in the movement direction, the wiping portion readily wipes the liquid from all the outlets at one time. The wiping portion has a higher ability to wipe the liquid.

In the printing apparatus,

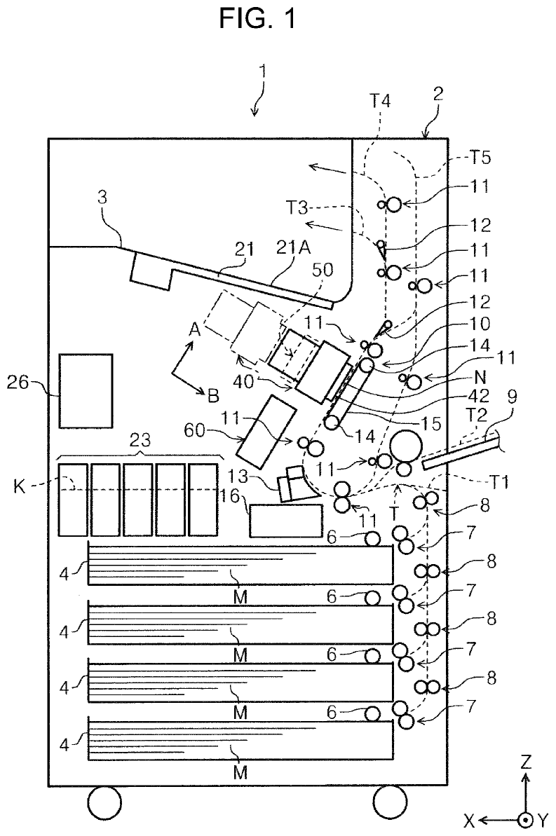

Hereinafter, a printer 1 will be described in detail as an example of the printing apparatus according to an embodiment of the present disclosure. FIG. 1 illustrates a printer 1. The printer 1 is an ink jet printer that ejects ink K, which is an example of a liquid, onto a medium M, such as a recording sheet for recording. In the drawings, the X-Y-Z coordinate system is a Cartesian coordinate system. The X direction corresponds to an apparatus width direction viewed from the user of the printer 1 and is the horizontal direction. The X direction includes a +X direction directed toward the left and a −X direction directed toward the right. The Y direction corresponds to a width direction of the medium M, which intersects a transportation direction of the medium M, an apparatus depth direction, and the horizontal direction. The Y direction intersects both A and B directions, which will be described later. The Y direction includes a +Y direction directed toward the front and a −Y direction directed toward the rear. Furthermore, the Y direction is an example of the movement direction of a wiper unit 50, which will be described later, and intersects both the Z direction and the A direction, which will be described later. The Z direction corresponds to the printer height direction and is the vertical direction, for example. The Z direction includes a +Z direction directed upward and a −Z direction directed downward.

In the printer 1, the medium M is transported along the transportation path T indicated by a broken line. The A-B coordinate system indicated in the XZ-plane is a Cartesian coordinate system. The A direction corresponds to a transportation direction of the medium M in a transportation path T over an area facing a line head 40, which will be described later. The A direction includes a −A direction directed upstream and a +A direction directed downstream. The A direction is an example of the intersecting direction that intersects the Z direction. In this embodiment, the A direction is tilted such that the +A direction side of the transportation path T is positioned higher in the +Z direction than the −A direction side of the transportation path T. Specifically described, the A direction is tilted with respect to the Z direction at an angle of 20 to 40 degrees, more specifically at an angle of about 30 degrees. In other words, the A direction is tilted with respect to the X direction at an angle of about 60 degrees.

The B direction is an example of the perpendicular direction perpendicular to an ejection surface 42, which will be described later, and corresponds to a movement direction of the line head 40 toward or away from a transportation unit 10, which will be described later. The B direction includes a +B direction in which the line head 40 moves toward the transportation path T and a −B direction in which the line head 40 moves away from the transportation path T. The B direction is tilted such that the −B direction side is positioned higher in the +Z direction than the +B direction side.

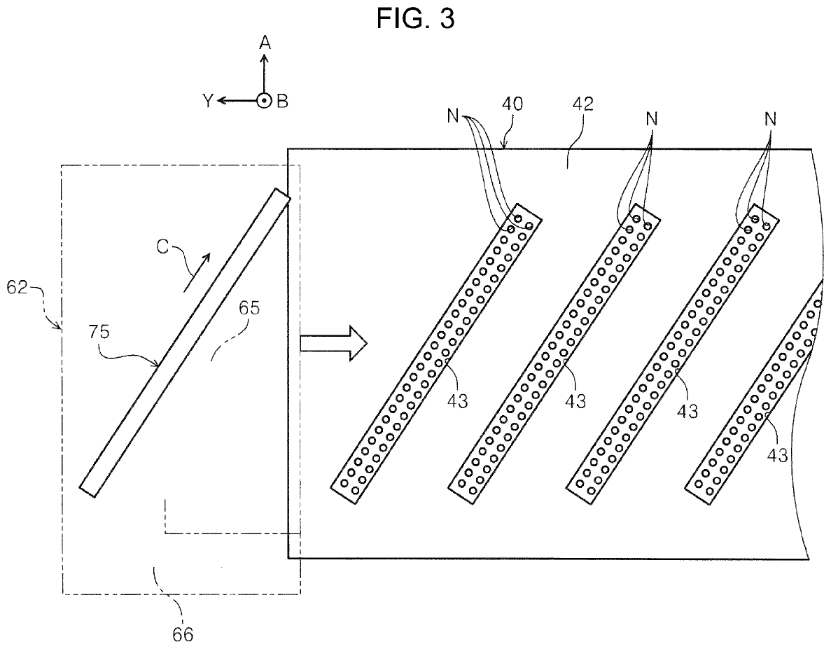

As illustrated in FIG. 3, one direction in which a main blade 75, which will be described later, extends is referred to as a C direction. The C direction intersects both the Y direction and the A direction and is an example of the arrangement direction of nozzles N, which will be described later.

As illustrated in FIG. 1, the printer 1 includes a housing 2, which is an example of an apparatus body. The housing 2 has a discharging portion 3 having a space to receive the recorded medium M above the center of the housing 2 in the +Z direction. The housing 2 further includes medium cassettes 4. The medium cassettes 4 hold the medium M. The medium M in the medium cassettes 4 is transported by pick-up rollers 6 and transportation roller pairs 7 and 8 along the transportation path T. A transportation pathway T1 and a transportation pathway T2 are branches from the transportation path T. A medium M from an external device is fed through the transportation pathway T1. A medium from a manual feed tray 9 attached to the housing 2 is fed through the transportation pathway T2.

On the transportation path T, a transportation unit 10, multiple transportation roller pairs 11 that send the medium M, flaps 12 that switch the transportation paths that transports the medium M, and a medium width sensor 13 that determines the width in the Y direction of the medium M. The transportation unit 10 includes two pulleys 14, an endless transportation belt 15 wound on the two pulleys 14, and a motor (not illustrated) that drives one of the pulleys 14. The medium M is transported in the +A direction over an area facing the line head 40, which will be described later, while being held on the surface of the transportation belt 15. The transportation path T extends from the medium width sensor 13 in the +A direction. In the transportation path T, transportation pathways T3 and T4 extending to the discharging portion 3 and an inversion path T5 where the medium M are located downstream of the transportation unit 10. The discharging portion 3 has a discharging tray 21 on the bottom. The discharging tray 21 has a placement surface 21A on which the medium M is placed.

Furthermore, the housing 2 includes an ink tank 23 that contains ink K, a waste liquid storage 16 that stores waste of ink K, and a controller 26 that controls motions of the components of the printer 1. The ink tank 23 supplies the ink K to the line head 40 through tubes (not illustrated). The waste liquid storage 16 stores the ink K as a waste liquid collected in a wiper unit 50 or a cap unit 60, which will be described later. The controller 26 includes a central processing unit (CPU), read-only memory (ROM), random-access memory (RAM), and a storage to control transportation of the medium M in the printer 1 and control movement of the components including the line head 40 and the wiper unit 50.

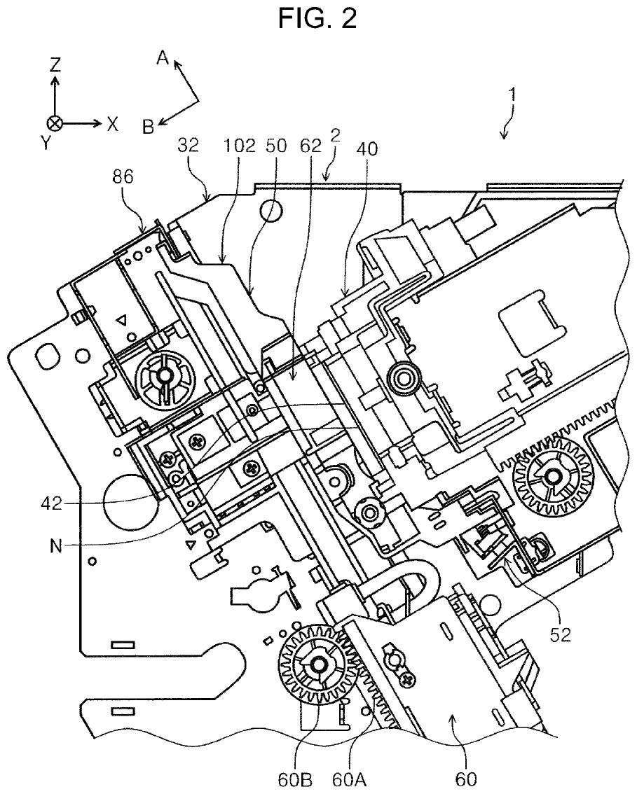

FIG. 2 illustrates the inside of the housing 2 viewed in the +Y direction from the −Y direction. The housing 2 includes side frames 32 in the inside. Although two side frames 32 are disposed with a space in the Y direction, only one on the +Y direction side is illustrated in FIG. 2. The side frames 32 are formed of sheet metal and extend vertically from the bottom frame (not illustrated) of the printer 1 along the A-B plane and the X-Z plane. The side frame 32 on the −Y direction side has a through hole (not illustrated). The wiper unit 50, which will be described later, passes through the through hole in the Y direction. The home position of the wiper unit 50 is located on the −Y direction side of the side frame 32 on the −Y direction side. The two side frames 32 are coupled to each other by a lateral frame (not illustrated) extending in the Y direction. The line head 40 is located between the two side frames 32.

As illustrated in FIG. 1, the printer 1 includes the line head 40, the wiper unit 50, the cap unit 60, and a guiding portion 86 and a wiper carriage 102 (FIG. 2). The line head 40 is an example of the recording portion. The line head 40 is driven by a movement mechanism (not illustrated) to move in a B direction, which is a direction toward or away from the transportation unit 10, to a recording position or a retracted position. The line head 40 at the recording position records information on the medium M while facing the medium M in the B direction. The retracted position is away from the recording position in the −B direction.

As illustrated in FIG. 3, the line head 40 has an ejection surface 42. The ejection surface 42 extends along the A-Y plane, for example. The ejection surface 42 has grooves 43 arranged in the Y direction. The grooves 43 have a rectangular shape elongated in the C direction, which intersects both the A direction and the Y direction, when viewed from the −Z direction. The grooves 43 are recesses in the ejection surface 42 and recessed in the −B direction. The grooves 43 have nozzles N through which the ink K is ejected at the bottoms. In other words, the ejection surface 42 has the nozzles N. The nozzles N are an example of the outlets and arranged in the C direction to cover all the area of the medium M in the Y direction. In this configuration, the line head 40 ejects the ink K through the nozzles N in the ejection surface 42 to record on the medium M.

As illustrated in FIG. 2, the cap unit 60 is reciprocated in the A direction by a drive mechanism including a rack 60A and a pinion 60B. When the line head 40 is moved to the recording position, the cap unit 60 is moved away from the line head 40 in the −A direction. Furthermore, when the line head 40 is positioned at the retracted position, the cap unit 60 is moved in the +A direction to cover the nozzles N and receive the ink K ejected through the nozzles N.

The wiper unit 50 is an example of the cleaner and is reciprocated in the Y direction by a drive unit 52, which will be described later. When the line head 40 is moved to the recording position, the wiper unit 50 is moved away from the line head 40 in the −Y direction. When the line head 40 is positioned at the retracted position, the wiper unit 50 is moved in the +Y direction and then cleans the ejection surface 42 with a wiping portion 75B while being moved in the −Y direction. In other words, the wiper unit 50 wipes the ink K from the ejection surface 42. Specifically described, the wiper unit 50 includes a blade unit 62 and a wiper carriage 102.

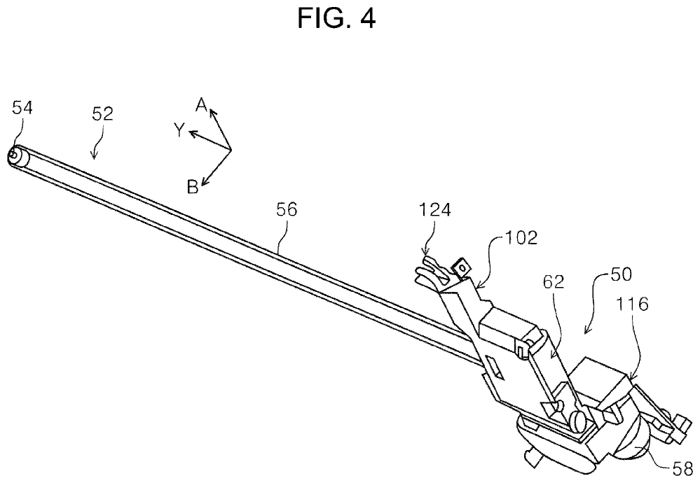

As illustrated in FIG. 4, the drive unit 52 is an example of the drive and drives the wiper unit 50, or the wiper carriage 102 and the blade unit 62, in the Y direction. Specifically described, the drive unit 52 includes a pair of pulleys 54, a timing belt 56, and a motor 58 that rotates one of the pulleys 54. In FIG. 4, only one of the pulleys 54 is illustrated and the other is not illustrated. The timing belt 56 is wound on the two pulleys 54. The timing belt 56 has a portion fixed to a portion of a guided portion 116, which will be described later. With this configuration, when one of the pulleys 54 is rotated in a positive direction by the motor 58, the wiper carriage 102 and the blade unit 62 are moved in the +Y direction. Furthermore, when the other of the pulleys 54 is rotated by the motor 58 in a negative direction, the wiper carriage 102 and the blade unit 62 are moved in the −Y direction. In this way, the drive unit 52 drives the portion of the wiper unit 50 having the guided portion 116 in the Y direction.

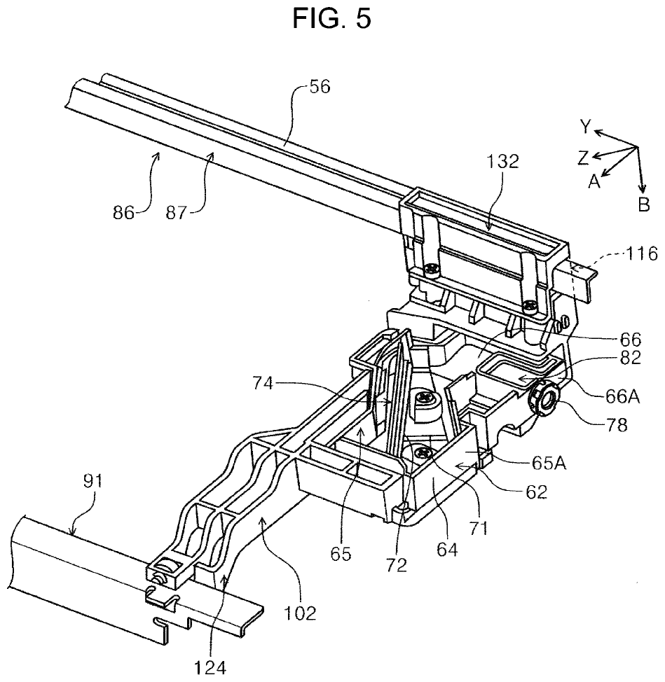

As illustrated in FIG. 5, the blade unit 62 is configured to clean the ejection surface 42 (FIG. 3). Specifically described, the blade unit 62 includes a unit body 64, a base frame 71, an attachment frame 72, a blade 74, and a cover 82. The unit body 64 has a box-like shape opening in the −B direction. The unit body 64 includes a blade mounting portion 65, an ink container 66, and a receiving portion 78.

The blade mounting portion 65 is a portion surrounded by a side wall 65A. The ink container 66 is a chamber surrounded by a side wall 66A and is located away in the −A direction from the center of the unit body 64 in the A direction. Furthermore, the ink container 66 is a space defined by the unit body 64 and the cover 82, which will be described later, and is in communication with the inside of the blade mounting portion 65. The ink container 66 is an example of the liquid container. The ink container 66 is located below the blade 74 in the Z direction and configured to hold the ink K (FIG. 1) wiped by the blade 74.

In the unit body 64, the receiving portion 78 is adjacent to the blade mounting portion 65 in the −A direction. Furthermore, in the unit body 64, the receiving portion 78 is adjacent to the ink container 66 in the +A direction and the −Y direction. The receiving portion 78 has a cylindrical shape having an axis extending in the Y direction. The inside of the receiving portion 78 is in communication with the inside of the ink container 66. A wiper needle (not illustrated) is inserted into the receiving portion 78 in the +Y direction. In this state, suctioning by the wiper needle makes the pressure in the receiving portion 78 negative, allowing the ink K in the ink container 66 to discharge from the unit body 64 through the receiving portion 78 and the wiper needle. In this embodiment, as an example, the end in the +A direction of the ink container 66 aligns with the end in the +A direction of the receiving portion 78, and the end in the −A direction of the ink container 66 aligns with the end in the −A direction of the side wall 66A. This defines the width in the A direction of the ink container 66.

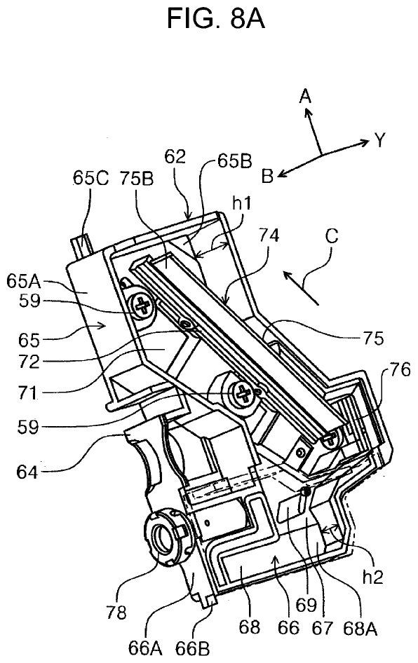

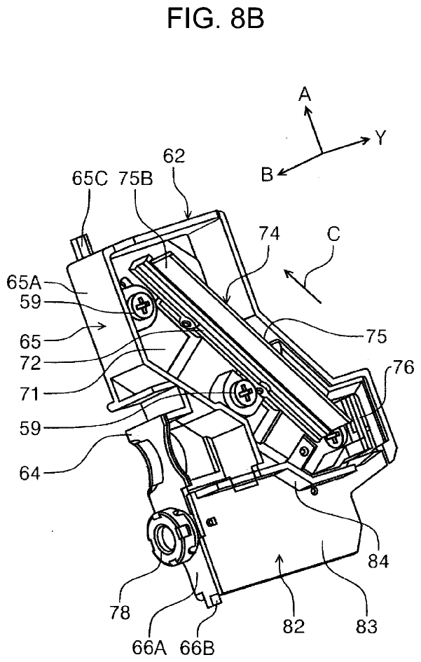

As illustrated in FIG. 8A, the side wall 65A has a first engagement portion 65C on the end in the +A direction and the −Y direction. The first engagement portion 65C protrudes from the side wall 65A in the +A direction. The first engagement portion 65C has a plate-like shape having a predetermined thickness in the B direction. The side wall 66A has a second engagement portion 66B on the end in the −A direction and the −Y direction. The second engagement portion 66B protrudes from the side wall 66A in the −A direction. The second engagement portion 66B has a plate-like shape having a predetermined thickness in the B direction.

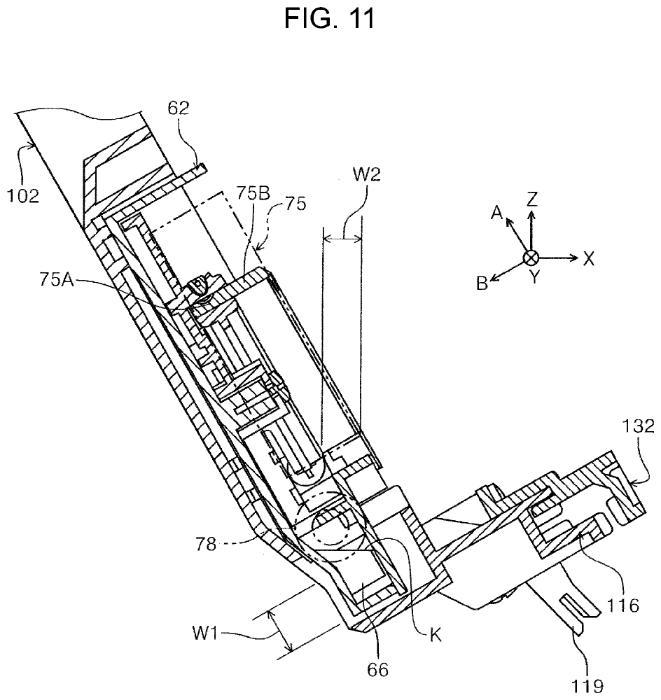

The blade 74 includes a main blade 75 and a sub-blade 76, for example. The main blade 75 is an example of the blade. The main blade 75 is formed of rubber and has a plate-like shape having a predetermined thickness in a direction intersecting the C direction when viewed in the B direction. The main blade 75 is elongated in the C direction. Furthermore, the main blade 75 is tilted such that the end in the −Y direction is positioned higher in the +A direction than the end in the +Y direction, for example. Specifically described, the main blade 75 includes a fixed portion 75A (FIG. 11) and a wiping portion 75B arranged in the B direction. The fixed portion 75A is a portion of the main blade 75 adjacent to the center in the B direction of the main blade 75 in the +B direction and is fixed to the blade mounting portion 65. The wiping portion 75B is a portion of the main blade 75 adjacent to the center in the B direction of the main blade 75 in the −B direction and is elastically deformable. The wiping portion 75B is elastically deformed to wipe the ink K when brought in contact with the ejection surface 42 (FIG. 3).

As illustrated in FIG. 3, the main blade 75 extends in the C direction along the array of the nozzles N. The main blade 75 is positioned to come in contact with the grooves 43. The main blade 75 wipes the ink K from the ejection surface 42. The ink K wiped by the main blade 75 is allowed to flow in the blade mounting portion 65 toward the ink container 66 due to the slope of the main blade 75 and its own weight.

As illustrated in FIG. 8A, the sub-blade 76 is located on the +Y direction side of the end in the +Y direction of the main blade 75. The sub-blade 76 is formed of rubber and has a plate-like shape having a predetermined thickness in the Y direction when viewed in the B direction. Furthermore, the sub-blade 76 extends in the A direction. The sub-blade 76 comes in contact with the side surface of the line head 40 (FIG. 3) facing in the +Y direction to wipe the ink K from the side surface of the line head 40 facing in the +Y direction.

The base frame 71 is fastened to the blade mounting portion 65 with screws 59. The attachment frame 72 is attached to the base frame 71 while sandwiching the +B direction side lower end of the main blade 75 with the base frame 71. The main blade 75 is held in this way. In the same way, the sub-blade 76 is held by the base frame 71. The main blade 75 and the sub-blade 76 protrude in the −B direction from the −B direction end face of the unit body 64.

The ink container 66 includes an inflow portion 67 opening toward the blade mounting portion 65 and a storage 68 extending in the −Y direction from the end in the −A direction of the inflow portion 67. The end in the +A direction of the inflow portion 67 aligns with the end in the −A direction of the sub-blade 76. The portion of the inflow portion 67 extending in the +A direction from the center in the A direction has a flow passage area gradually decreasing toward the storage 68. A flow straightener 69 is disposed in the inflow portion 67. The flow straightener 69 is tilted in a direction intersecting the A direction and guides the ink K into the storage 68.

The dimension of the blade mounting portion 65 in the B direction is defined as a depth h1 (mm). The dimension of the ink container 66 in the B direction is defined as a depth h2 (mm). In this embodiment, h2<h1 is satisfied, for example. In other words, a surface 68A of the storage 68 on the +B direction side is located higher in the −B direction than a surface 65B of the blade mounting portion 65 on the +B direction side.

As illustrated in FIG. 8B, the blade unit 62 has the cover 82. The cover 82 is a light-transmitting transparent member, for example. However, in FIG. 8B, the cover 82 is not transparent to show the outline of the cover 82. The cover 82 is attached to the unit body 64 by thermal welding, for example, and covers the storage 68 (FIG. 8A) from the −B direction. Specifically described, the cover 82 includes a lid 83 and a flange 84. The lid 83 has a plate-like shape having a predetermined thickness in the B direction and covers the storage 68 from the −B direction. The flange 84 protrudes in the −B direction from the end in the +A direction of the cover 83. The flange 84 is located below the main blade 75 in the −A direction to guide the ink K, which has dropped from the main blade 75, in the inflow portion 67 (FIG. 8A).

As illustrated in FIG. 5, the guiding portion 86 is an example of the guide that guides the blade unit 62 and the wiper carriage 102 and extends in the Y direction. Specifically described, the guiding portion 86 includes a first guide rail 87 and a second guide rail 91 extending in the Y direction parallel to each other. The first guide rail 87 is an example of the guide and functions as a main shaft that guides the wiper carriage 102 and the blade unit 62. The second guide rail 91 is an example of the auxiliary guide and functions as an auxiliary shaft that guides the wiper carriage 102 and the blade unit 62. The second guide rail 91 is away from the first guide rail 87 in the +A direction and the +B direction. The second guide rail 91 extends in the Y direction parallel to the first guide rail 87.

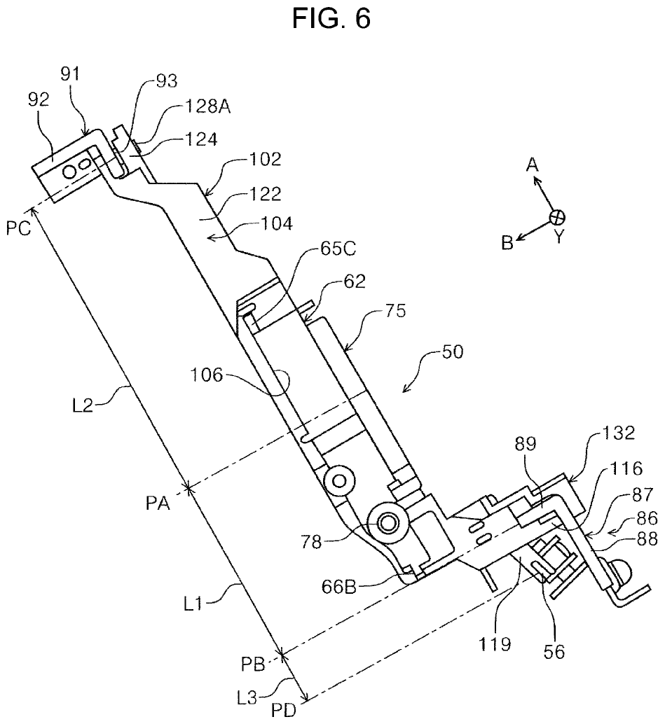

As illustrated in FIG. 6, the first guide rail 87 is formed of sheet metal having an L-like shape in a cross-section along the A-B plane. Specifically described, the first guide rail 87 includes a first plate 89 and a second plate 88. The second plate 88 has a predetermined thickness in the B direction and extends in the Y direction along the A-Y plane. An end in the −A direction of the second plate 88 is integral with one of the lateral frames. The first plate 89 extends in the +B direction from the end in the +A direction of the second plate 88. Furthermore, the first plate 89 has a predetermined thickness in the A direction and extends in the Y direction along the B-Y plane. The length of the first plate 89 in the B direction is shorter than the length of the second plate 88 in the A direction.

The second guide rail 91 is formed of sheet metal having an L-like shape in the cross section along the A-B plane. Specifically described, the second guide rail 91 includes an attachment portion 92 and a third plate 93. The attachment portion 92 has a predetermined thickness in the A direction and extends in the Y direction along the B-Y plane. An end in the +B direction of the attachment portion 92 is fixed to the other of the lateral frames. The third plate 93 extends from an end in the −B direction of the attachment portion 92. Furthermore, the third plate 93 has a predetermined thickness in the B direction and extends in the Y direction along the A-Y plane. The length of the third plate 93 in the A direction is shorter than the length of the attachment portion 92 in the B direction.

The wiper carriage 102 is an example of a support and supports the blade unit 62 from the +B direction. Specifically described, the wiper carriage 102 includes a first frame member 104 and a second frame member 132. The first frame member 104 includes a mounting portion 106, a guided portion 116, an arm 122, and an auxiliary guided portion 124. The guided portion 116 is guided by the guiding portion 86. The blade unit 62 is mounted on the mounting portion 106. The guided portion 116 extends straight in the −B direction from the end in the −A direction of the mounting portion 106. The arm 122 extends in the +A direction from the end in the +A direction of the mounting portion 106. The auxiliary guided portion 124 is disposed on the end in the +A direction of the arm 122.

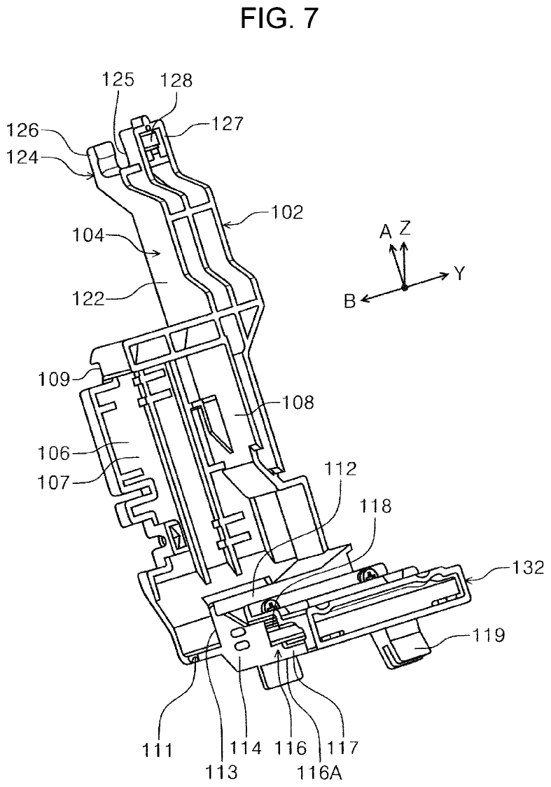

As illustrated in FIG. 7, the mounting portion 106 includes a bottom wall 107 extending along the A-Y plane and a peripheral wall 108 extending up in the −B direction from the ends in the A direction and the end in the +Y direction of the bottom wall 107. An engaged portion 109 is located at the end in the +A direction and the −Y direction of the peripheral wall 108. The first engagement portion 65C (FIG. 6) engages with the engaged portion 109. An engaged portion 111 is located at the end in the −A direction and the −Y direction of the peripheral wall 108. The second engagement portion 66B (FIG. 6) engages with the engaged portion 111. An upper wall 112 is disposed at the end in the −A direction of the peripheral wall 108. The upper wall 112 extends in the +A direction from the end in the −B direction of the peripheral wall 108. In this configuration, the bottom wall 107, the peripheral wall 108, and the upper wall 112 define a hollow 113 at the end in the −A direction of the mounting portion 106. The ink container 66 (FIG. 8A) is housed in the hollow 113.

The guided portion 116 extends in the −B direction from the upper wall 112. The guided portion 116 has a U-like shaped portion opening in the −B direction when viewed in the Y direction and having vertical walls 117 and 118. The vertical wall 117 extends in the B direction. The vertical wall 118 is away from the vertical wall 117 in the +A direction and faces the vertical wall 117 in the A direction. The vertical wall 118 is shorter than the vertical wall 117 in the B direction. The vertical wall 118 is in contact with the first plate 89 in the A direction. Furthermore, the guided portion 116 is located below the auxiliary guided portion 124 in the Z direction. An attachment member 119 is disposed on a side surface 116A of the guided portion 116 facing in the −A direction. The attachment member 119 extends from the side surface 116A in the −A direction. A portion of the timing belt 56 (FIG. 4) is fixed to the attachment member 119.

The arm 122 extends in the +A direction from the end in the +A direction and the +Y direction of the peripheral wall 108. The auxiliary guided portion 124 is disposed at the end in the +A direction of the arm 122 and is guided by the second guide rail 91 in the Y direction. Furthermore, the auxiliary guided portion 124 has a recess 125. The recess 125 has a U-like shape opening in the +A direction when viewed in the Y direction and has lateral walls 126 and 127. The third plate 93 (FIG. 6) is inserted into the recess 125 in the −A direction. The lateral wall 126 extends in the +A direction from the end in the +A direction of the arm 122. The lateral wall 127 is away from the lateral wall 126 in the −B direction and faces the lateral wall 126 in the B direction. The lateral wall 127 is longer than the lateral wall 126 in the A direction. The lateral wall 127 has a roller 128 rotatable about a shaft extending in the A direction (not illustrated). The roller 128 protrudes partly from the lateral wall 127 in the +B direction.

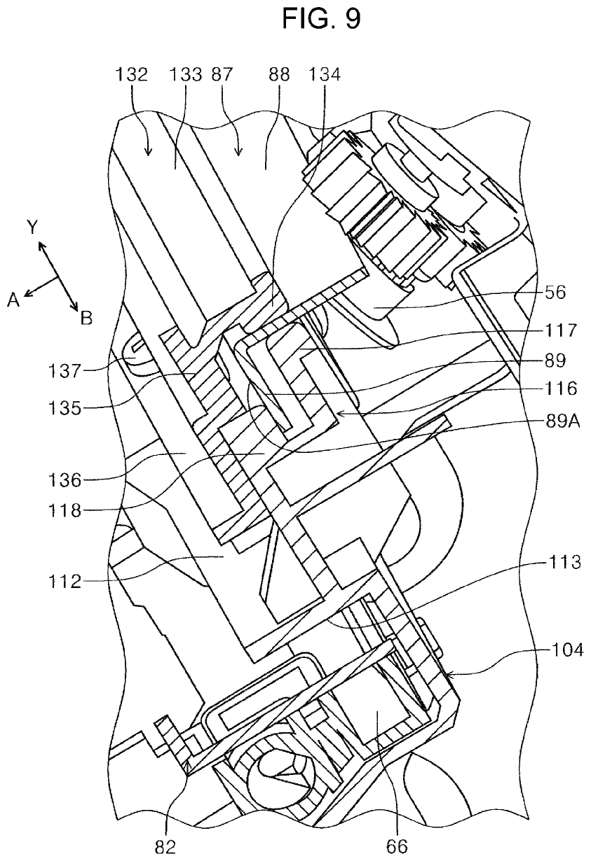

As illustrated in FIG. 9, the second frame member 132 is disposed on the guided portion 116. The second frame member 132 is an example of the sandwiching portion and sandwiches the second plate 88 with the guided portion 116 in the B direction. Specifically described, the second frame member 132 has an upper wall portion 133, a vertical wall portion 135, and a flange portion 136. The upper wall portion 133 extends in the Y direction along the A-Y plane. A protrusion 134 protrudes from the upper wall portion 133 in the +B direction. The protrusion 134 faces the vertical wall 117 in the B direction with the first guide rail 87 being disposed therebetween. The vertical wall portion 135 extends in the +B direction from the end in the +A direction of the upper wall portion 133. The flange portion 136 extends in the +A direction from the end in the +B direction of the vertical wall portion 135. The flange portion 136 is fastened to the upper wall 112 with a screw 137 to cover the guided portion 116 with the second frame member 132 from the −B direction.

The first plate 89 is located between the vertical wall 117 and the vertical wall 118. The protrusion 134 and the vertical wall 117 sandwich the second plate 88 therebetween in the B direction. The vertical wall 118 is pressed against a side surface 89A of the first plate 89 facing in the +A direction under the weight of the first frame member 104. This configuration enables the guided portion 116 to move in the Y direction while being guided by the first guide rail 87 and limits the movement of the guided portion 116 in the A direction and the B direction.

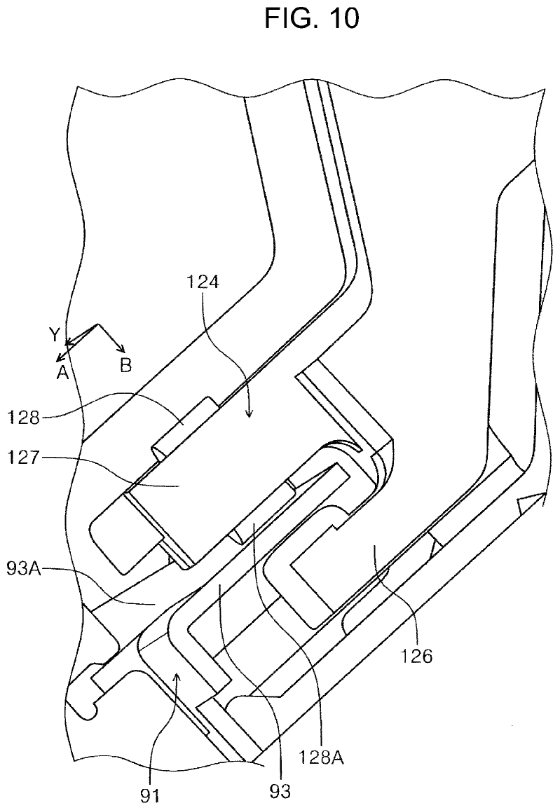

As illustrated in FIG. 10, the third plate 93 is located between the lateral wall 126 and the lateral wall 127. An outer circumferential surface 128A of the roller 128 is pressed against a surface 93A of the third plate 93 facing in the −B direction under its own weight. This configuration enables the auxiliary guided portion 124 to move in the Y direction while being guided by the second guide rail 91 and limits the movement of the auxiliary guided portion 124 in the B direction. In other words, the auxiliary guided portion 124 moves more freely than the guided portion 116 (FIG. 9).

As illustrated in FIG. 11, the ink container 66 and the guided portion 116 form an overlap in the A direction. In other words, the ink container 66 and the guided portion 116 form an overlapping area W1 (mm) extending in the A direction. The main blade 75 and the ink container 66 form an overlap in the X direction. In other words, the main blade 75 and the ink container 66 form an overlapping area W2 (mm) extending in the X direction. The ink container 66 and the wiping portion 75B do not form an overlap in the B direction.

As illustrated in FIG. 6, when viewed in the Y direction, the center in the A direction of the main blade 75 is referred to as a position PA. The position PA is also the center in the C direction of the main blade 75 (FIG. 3). The position of the guided portion 116 in the A direction is referred to as a position PB. In this embodiment, the center of the first plate 89 is used as the position of the guided portion 116. The position of the auxiliary guided portion 124 in the A direction is referred to as a position PC. In this embodiment, the center of the outer circumferential surface 128A is used as the position of the guided portion 124. The center in the A direction of the timing belt 56 attached to the attachment member 119 is referred to as a position PD. The wiper carriage 102 directly receives a driving force at the position PD. The distance from the position PB to the position PA in the A direction is defined as a first distance L1 (mm). The distance from the position PC to the position PA in the A direction is defined as a second distance L2 (mm). The distance from the position PB to the position PD in the A direction is defined as a third distance L3 (mm). The first distance L1 is shorter than the second distance L2. The third distance L3 is shorter than the first distance L1.

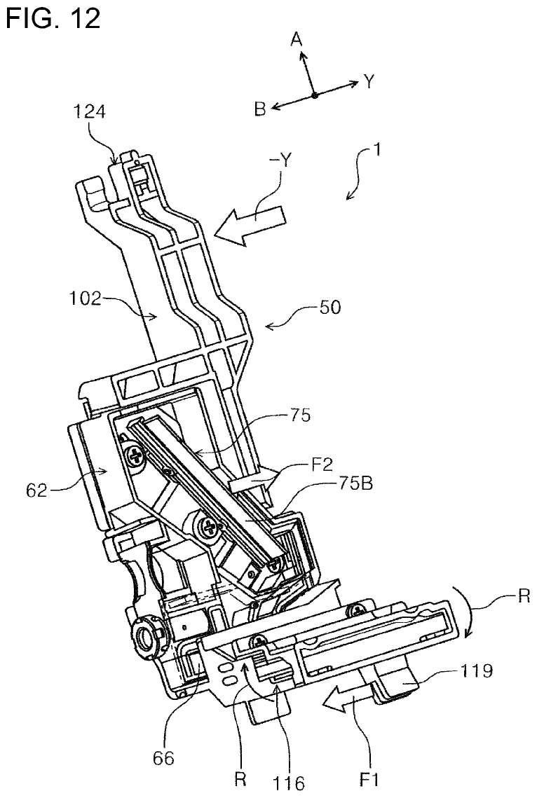

Next, the operation of the printer 1 will be described. The components that have been illustrated in any one of FIG. 1 to FIG. 11 will not be designated by the reference numerals. FIG. 12 schematically illustrates how forces are applied to the components of the wiper unit 50 when the wiper unit 50 is moved in the −Y direction to wipe the ink K from the ejection surface 42 (FIG. 3) with the main blade 75. A driving force F1 is applied to the guided portion 116 of the wiper unit 50 in the −Y direction while the wiper unit 50 is positioned at the end in the +Y direction of the printer 1. This force moves the wiper unit 50, or the blade unit 62 and the wiper carriage 102, in the −Y direction.

When the blade unit 62 and the wiper carriage 102 are moved in the −Y direction, the wiping portion 75B wipes the ink K from the ejection surface 42 (FIG. 3). The wiped ink K is held in the ink container 66. When the wiping portion 75B wipes the ink K from the ejection surface 42, a reaction force F2 in the +Y direction opposite the −Y direction is applied to the wiping portion 75B at the point of application of the force. The reaction force F2 causes a moment of force at the contact point between the guiding portion 86 (FIG. 6) and the guided portion 116.

Specifically described, the wiper carriage 102 receives the driving force F1 at a portion on the −A direction side of the guided portion 116 and the reaction force F2 at a portion on the +A direction side of the guided portion 116. This causes a moment of force indicated by an arrow R at the contact point between the guided portion 116 and the first plate 89 (FIG. 9). The moment of force is a torque in the A-Y plane and becomes a “torsional force” acting on the guided portion 116.

Here, in the printer 1, the ink container 66 and the guided portion 116 form an overlap in the A direction. In this configuration, the first distance L1 from the wiping portion 75B to the contact point between the first guide rail 87 and the guided portion 116 is shorter than that in a printer in which the guided portion 116 is farther than the ink container 66 from the wiping portion 75B or a printer in which the ink container 66 and the guided portion 116 do not form an overlap in the A direction. This reduces the moment of force at the contact point between the first guide rail 87 and the guided portion 116. Thus, a load due to torsion is less likely to act on the guided portion 116. Meanwhile, the load due to torsion is less likely to act on the auxiliary guided portion 124, because the auxiliary guided portion 124 is movable in the A direction and the Y direction with a high degree of freedom at the contact point between the second guide rail 91 and the auxiliary guided portion 124.

The printer 1 requires a smaller installation space for the wiping portion 75B and the ink container 66 in the X direction than a printer in which the wiping portion 75B and the ink container 66 are arranged in the X direction. This enables the printer 1 to be smaller in the X direction. In the printer 1, the ink container 66 and the wiping portion 75B do not form an overlap in the B direction. This enables the path through which the ink K flows from the wiping portion 75B to the ink container 66 to be long. In other words, the path from the ink container 66 to the wiping portion 75B is made long. This prevents the ink K from reattaching to the wiping portion 75B when the ink K flowing toward the ink container 66 flows back toward the wiping portion 75B.

In the printer 1, the guided portion 116, which directly receives a driving force from the drive unit 52, is located closer than the auxiliary guided portion 124, which does not directly receive a driving force from the drive unit 52, to the main blade 75. This configuration further shortens the distance from the main blade 75 to the point of application where the driving force of the drive unit 52 acts. Thus, a load due to torsion is less likely to act on the guided portion 116. The ink K wiped by the wiping portion 75B flows downward in the Z direction under its own weight. In the printer 1, the guided portion 116 is located below the auxiliary guided portion 124 in the Z direction, and thus the ink container 66 is located below the wiping portion 75B in the Z direction. In this configuration, the ink K wiped by the wiping portion 75B is efficiently gathered into the ink container 66 without a component that guides the ink K into the ink container 66.

In the printer 1, the guided portion 116 is in contact with the first plate 89 in the A direction and the guided portion 116 and the second frame member 132 sandwich the second plate 88 in the B direction. This limits the movement of the guided portion 116 in the A direction and the B direction. Thus, the wiper unit 50 is less likely to misalign with the guiding portion 86. The auxiliary guided portion 124 is freely movable in the A direction in addition to the Y direction. In this configuration, when a reaction force opposite the Y direction acts on the wiping portion 75B, the auxiliary guided portion 124 and the second guide rail 91 are less likely to come in contact with each other. Thus, a load due to torsion is less likely to act on the auxiliary guided portion 124. In the printer 1, the main blade 75 is elongated in the C direction, which is the arrangement direction of the nozzles N. In this configuration, when the wiping portion 75B is moved in the Y direction, the wiping portion 75B readily wipes the ink K from all the nozzles N at one time. The wiping portion 75B has a higher ability to wipe the ink K.

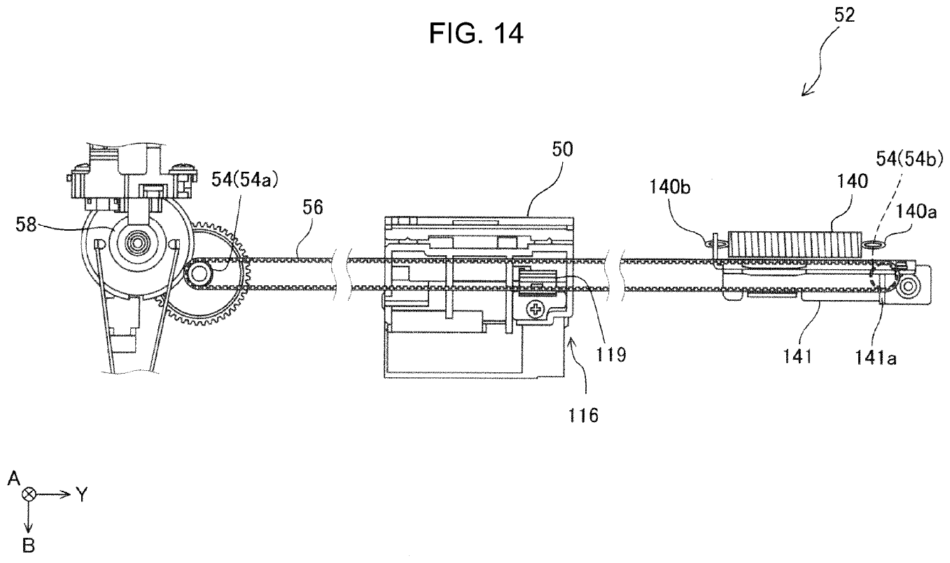

The wiper unit 50 as the cleaner of the printer 1 and the drive unit 52 as the drive unit of the wiper unit 50 will be described with reference to FIGS. 14, 15 and 16. As shown in FIG. 14, the printer 1 includes the drive unit 52 that drives the wiper unit 50 in the Y direction, which is the movement direction.

As shown in FIG. 14, the drive unit 52 includes the timing belt 56 which is an annular belt that engages with the wiper unit 50 via the attachment member 119, and two pulleys 54 around which the timing belt 56 is wound, and the motor 58 which is a drive source for moving the timing belt 56. The pulley 54 has a drive pulley 54a and a driven pulley 54b. The drive pulley 54a rotates by the rotational force applied by the motor 58. The drive pulley 54a is rotatable. The rotation of the drive pulley 54a causes the timing belt 56 to rotate and move. The driven pulley 54b rotates in accordance with the rotational movement of the timing belt 56. The drive unit 52 has a tension spring 140 as an urging portion that urges the driven pulley 54b in the +Y direction, which is the direction away from the drive pulley 54a.

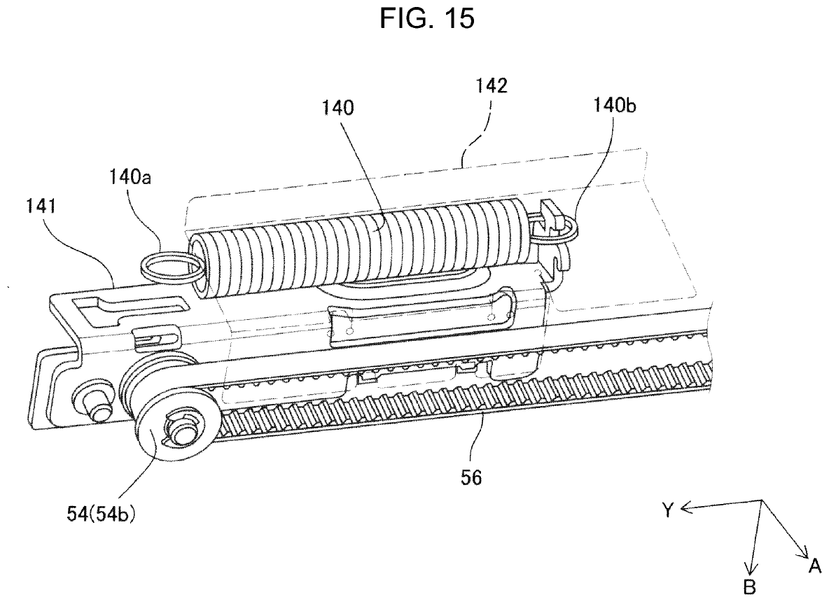

The timing belt 56 of this embodiment has an annular shape. The above-mentioned “annular belt” includes an annular shape that both ends of the linear belt are fixed by attachment member 119 or the like. The shape of the timing belt 56 itself is not particularly limited as long as it has an annular shape as the final form. As shown in FIGS. 14 and 15, the timing belt 56 is provided with an engagement portion. The engagement portion is provided on the inside of the loop of the timing belt 56. The drive pulley 54a has an engaged portion. The engagement portion and the engaged portion are engaged. If the engagement between the engagement portion and the engaged portion is misaligned and causes tooth skipping, it may cause problems in the moving operation of the wiper unit 50.

In the printer 1 of this embodiment, when the wiper unit 50 moves to the driven pulley 54b side (+Y direction side) in the movement direction of the wiper unit 50, the ejection surface 42 is not cleaned by the wiper unit 50. In the printer 1 of this embodiment, when the wiper unit 50 moves to the drive pulley 54a side (−Y direction side) in the movement direction of the wiper unit 50, the ejection surface 42 is cleaned by the wiper unit 50. The drive unit of the printer 1 of this embodiment includes the annular belt that engages with the wiper unit 50, the drive pulley 54a and the driven pully 54b that around which the belt is wound, and the tension spring 140 that urges the driven pulley 54b in a direction away from the drive pulley 54a. In this configuration, when a load is applied to the wiper unit 50 by contacting the ejection surface 42 while the wiper unit 50 is moving to the driven pulley 54b side, tooth skipping occurs due to poor movement of the wiper unit 50. In the printer 1 of this embodiment, the wiper unit 50 does not clean the ejection surface 42 when the wiper unit 50 moves to the driven pulley 54b side, but the wiper unit 50 cleans the discharge surface 42 when the wiper unit 50 moves to the drive pulley 54a side. Therefore, the printer 1 of the present embodiment can suppress the occurrence of tooth skipping on the timing belt 56 due to the load generated when the wiper unit 50 comes into contact with the discharge surface 42.

The above will be described in more detail with reference to FIG. 15. First, a configuration for moving the wiper unit 50 to the driven pulley 54b side will be described. When the wiper unit 50 is moved to the driven pulley 54b side (+Y direction side), the drive pulley 54a rotates in the counterclockwise direction (CCW direction), and the lower side of the timing belt 56, on which the attachment member 119 is provided, is pulled toward the +Y direction. In other words, the upper side of the timing belt 56 on which the attachment member 119 is not provided is pulled toward the −Y direction side. At this time, the wiper unit 50 is pulled by the drive pulley 54a via the driven pulley 54b. In this configuration, if a load due to torsion occurs in the guided portion 116, the wiper unit 50 itself cannot move in the +Y direction, but the upper side of the timing belt 56, which is not provided with the attachment member 119, receives the driving force from the drive pulley 54a. Since the driven pulley 54b is urged in the +Y direction by the tension spring 140, the driven pulley 54b itself has room to move in the −Y direction. Therefore, when the upper side of the timing belt 56 is pulled toward the −Y direction while a load due to torsion occurs in the guided portion 116, the driven pulley 54b opposes the urging force of the tension spring 140 and moves toward the −Y direction. In this case, the engagement portion of the timing belt 56 and the engaged portion of the drive pulley 54a may be out of mesh with each other, resulting in tooth skipping of the timing belt 56.

On the other hand, when the wiper unit 50 is moved to the drive pulley 54a side (−Y direction side), the drive pulley 54a rotates in the clockwise direction (CW direction), and the lower side of the timing belt 56, on which the attachment member 119 is provided, is pulled toward the −Y direction. Therefore, when a load due to torsion occurs in the guided portion 116, tooth skipping is unlikely to occur. Specifically, in a state where the guided portion 116 of the wiper unit 50 is twisted, that is, in a state where the wiper unit 50 is difficult to move, the timing belt 56 is less likely to be pulled toward the −Y direction side. This is because the movement direction of the wiper unit 50 is on the drive pulley 54a side. In such a state, the driving force of the drive pulley 54a is not significantly applied to the driven pulley 54b, and the driven pulley 54b is difficult to move in the −Y direction against the urging force of the tension spring 140. Therefore, the engagement portion of the timing belt 56 and the engaged portion of the drive pulley 54a are unlikely to be disengaged. In this way, by performing wiping when the wiper unit 50 moves to the drive pulley 54a, tooth skipping due to a load due to torsion occurs in the guided portion 116 can be reduced.

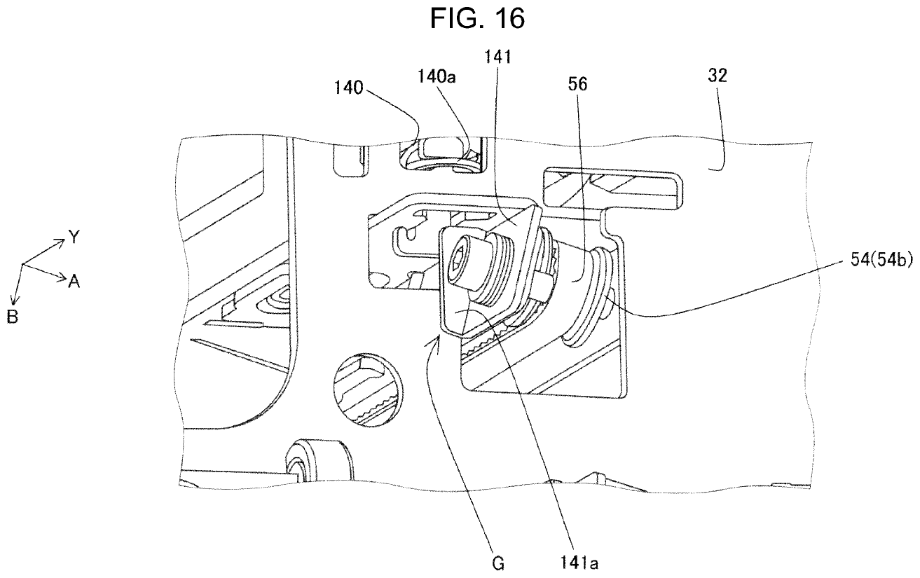

Next, the constituent members around the driven pulley 54b will be described in more detail with reference to FIGS. 15 and 16. As described above, the drive unit 52 of this embodiment has the tension spring 140 that urges the driven pulley 54b in the +Y direction. As shown in FIG. 16, one end 140a of the tension spring 140 is engaged with the side frame 32, and the other end 140b is engaged with the mounting plate 141 of the driven pulley 54b as shown in FIG. 15. The tension spring 140 urges the driven pulley 54b in the +Y direction, so that the timing belt 56 is in a state of being stretched with a desired tension. The urging portion of this embodiment is the tension spring 140 that applies a desired tension to the timing belt 56 via the driven pulley 54b, but the configuration of the urging portion is not particularly limited. Therefore, a configuration other than the tension spring may be used, or the timing belt 56 may be urged via the driven pulley 54b, or the timing belt 56 may be directly urged. If the tension applied to the timing belt 56 is too weak, the timing belt 56 tends to loosen and the timing belt 56 tends to tooth skip when a load due to torsion occurs in the guided portion 116. On the other hand, if the tension applied to the timing belt 56 is too strong, the load when moving the wiper unit 50, that is, when rotating the timing belt 56 becomes too large. Therefore, in this embodiment, grease is lubricated to the mounting plate 141 so that the timing belt 56 is in a state of being stretched with a desired tension. As shown in FIG. 15, a resin sheet 142 is provided around the mounting plate 141. The resin sheet 142 plays a role of suppressing the grease lubricated on the mounting plate 141 from dripping into the transport path of the medium M. As shown in FIG. 16, the mounting plate 141 has a perforated portion 141a formed at a position facing the side frame 32. A gap G is formed between the side frame 32 and the perforated portion 141a. When the tension is applied too strongly to the timing belt 56, the perforated 141a hits the side frame 32. With such a configuration, the timing belt 56 is prevented from being loosened beyond a certain level.

The printer 1 according to the embodiment of the present disclosure basically has the above-described configuration. However, the configuration may be partly changed or eliminated within a scope of the disclosure.

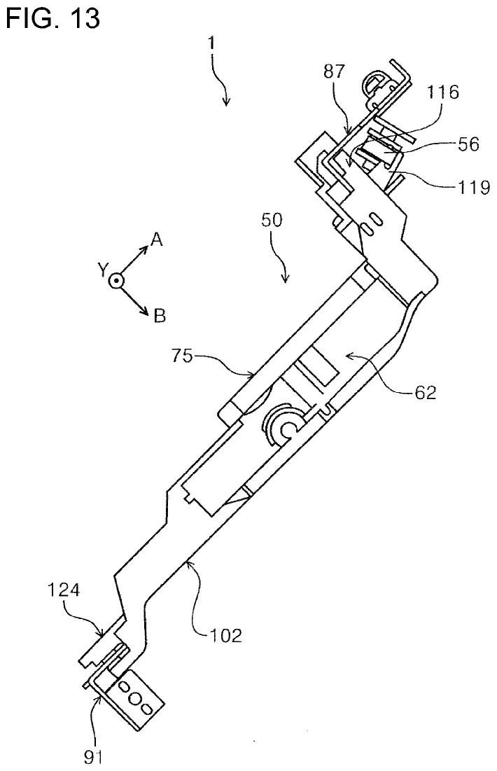

FIG. 13 illustrates a modification of the printer 1. The first guide rail 87 and the guided portion 116 are disposed on the +A direction side of the wiper unit 50. The second guide rail 91 and the auxiliary guided portion 124 are disposed on the −A direction side of the wiper unit 50. The modification has the same configuration as the printer 1 except for the above. In this modification, the first distance L1 is short, although the positions of the first guide rail 87 as the main shaft and the guided portion 116 relative to the blade unit 62 and the positions of the second guide rail 91 as the auxiliary shaft and the auxiliary guided portion 124 relative to the blade unit 62 are inverted. Thus, a load due to torsion is less likely to act on the guided portion 116 where a driving force acts.

In the printer 1, the wiping portion 75B and the ink container 66 may form no overlap in the X direction. Furthermore, the ink container 66 and the wiping portion 75B may form no overlap in the B direction. Furthermore, the first distance L1 may be longer than the second distance L2. In the printer 1, the auxiliary guided portion 124 may sandwich the third plate 93 in the B direction. The main blade 75 may extend in a direction other than the arrangement direction of the nozzles N.

The guiding portion 86, which guides the wiper unit 50 in the Y direction, may include only the first guide rail 87. Alternatively, the guiding portion 86 may include another guide rail in addition to the first guide rail 87 and the second guide rail 91. In other words, the printer 1 may include one guided portion 116 or three or more guided portions 116. The ink container 66 and the main blade 75 may form an overlap in the Z direction. Furthermore, the ink container 66 and the first plate 89 may form an overlap in the A direction. The blade 74 may include only the main blade 75. When the main blade 75 is the only component of the blade 74, the main blade 75 may extend in the A direction, not in the C direction.

In FIG. 12, the position where the driving force F1 acts, or the position PD in FIG. 6 is away from the position PB in the −A direction. However, the position PD may be away from the position PB in the +A direction, and the position PD may be any position within the first distance L1. In this configuration, a moment of force caused by the driving force F1 acting on the wiper unit 50 cancels out the moment of force R indicated in FIG. 12. This reduces the above-described problem of a load due to torsion.

What is claimed is:

1. A printing apparatus comprising:
a recording portion configured to eject a liquid from an ejection surface extending in an intersecting direction intersecting a vertical direction to record on a medium;
a cleaner including a wiping portion configured to wipe the liquid from the ejection surface and a liquid container located below the wiping portion in the vertical direction and configured to hold the liquid wiped by the wiping portion, the cleaner being configured to move in a movement direction intersecting both the vertical direction and the intersecting direction and clean the ejection surface with the wiping portion; and
a guide extending in the movement direction and configured to guide the cleaner, wherein
the cleaner includes a guided portion configured to be guided by the guide, and
the liquid container and the guided portion form an overlap in the intersecting direction when viewed in the movement direction.

2. The printing apparatus according to claim 1, wherein the wiping portion and the liquid container form an overlap in an apparatus width direction perpendicular to the vertical direction when viewed in the vertical direction.

3. The printing apparatus according to claim 2, wherein the liquid container and the wiping portion form no overlap in a perpendicular direction perpendicular to the ejection surface.

4. The printing apparatus according to claim 1, further comprising:
a drive configured to move the cleaner in the movement direction;
an auxiliary guide extending in the movement direction parallel to the guide; and
an auxiliary guided portion configured to be guided by the auxiliary guide, wherein
the wiping portion is a blade elongated in one direction,
the drive is configured to move a portion including the guided portion of the cleaner in the movement direction, and
in the intersecting direction, a first distance from the guided portion to a center of the blade in the one direction is shorter than a second distance from the auxiliary guided portion to the center.

5. The printing apparatus according to claim 4, wherein the guided portion is located below the auxiliary guided portion in the vertical direction.

6. The printing apparatus according to claim 4, wherein the guide includes a first plate having a thickness in the intersecting direction and a second plate having a thickness in a perpendicular direction perpendicular to the ejection surface,
the auxiliary guide includes a third plate having a thickness in the perpendicular direction,
the guided portion is in contact with the first plate in the intersecting direction,
a sandwiching portion sandwiching the second plate with the guided portion in the perpendicular direction is disposed on the guided portion, and
the auxiliary guided portion has a recess in which the third plate is inserted in the intersecting direction.

7. The printing apparatus according to claim 4, wherein the ejection surface has outlets arranged in an arrangement direction intersecting the movement direction, and
the blade is located such that the one direction extends in the arrangement direction.

8. The printing apparatus according to claim 1, further comprising:
a drive unit that drives the cleaner in the movement direction, wherein
the drive unit includes an annular belt that engages with the cleaner, and a drive pulley around which the belt is wound, and a drive source that rotates the drive pulley, and a driven pulley on which the belt is wound and which rotates in accordance with the movement of the belt caused by the rotation of the drive pulley, and an urging portion that urges the driven pulley in a direction away from the drive pulley, wherein
the cleaner does not clean the ejection surface when moving to the driven pulley side in the movement direction, and clean the ejection surface when moving to the drive pulley side in the movement direction.
